(19) United States
(12) Patent Application Publication
(10) Pub. No.: US 2016/0054969 A1
(43) Pub. Date: Feb. 25, 2016

(54) DISPLAY CONTROL APPARATUS CONTROLLING GRADATION CHARACTERISTICS OF DISPLAY APPARATUS, DISPLAY SYSTEM, AND DISPLAY CONTROL METHOD

(71) Applicant: CANON KABUSHIKI KAISHA, Tokyo (JP)

(72) Inventor: Kazuna Maruyama, Fuchu-shi (JP)

(21) Appl. No.: 14/828,191

(22) Filed: Aug. 17, 2015

(30) Foreign Application Priority Data
Aug. 21, 2014 (JP) 2014-168355

(51) Int. Cl. G06F 3/14; G09G 3/20; G09G 3/34

(52) U.S. Cl. CPC G06F 3/1423; G09G 3/3406; G09G 3/2003; G09G 2320/0271

(57) ABSTRACT

A display control apparatus includes an information obtaining unit that obtains image reading area information indicating a display area of a read image and image type information indicating a type of the read image, a gradation control unit that specifies one or more displays displaying read images from among a plurality of displays based on the image reading area information, and a command issuance unit that sets gradation characteristics of the one or more displays specified by the gradation control unit to gradation characteristics corresponding to the image type information.

### BACKGROUND

1. Field

Aspects of the present invention generally relate to a display control apparatus controlling gradation characteristics of a display apparatus, a display system, and a display control method.

2. Description of the Related Art

Display systems have been known which constitute a multiple screen using a plurality of displays and display a single image or a plurality of different images on the multiple screen. Japanese Patent Application Laid-Open No. 7-322181 describes a method for switching whether to perform gamma correction uniformly on all displays or individually on each display depending on whether a displayed image is a single image or a plurality of different images in a multiple screen display apparatus using a plurality of displays.

Recently, diagnostic imaging has been performed in which diagnosis is performed by displaying a medical image captured by a medical diagnosis apparatus on a display. Medical images include a tomographic image captured by a tomography diagnosis apparatus, such as a computer tomography (CT) and a magnetic resonance imaging (MRI), an image captured in endoscopy, and the like. In the diagnostic imaging using displays, comparative image reading in which images are read by displaying current and past medical images on adjacent displays, electronic medical chart editing in which a chart is created while viewing a medical image, and other operations are performed. Which medical image is displayed on which display among a plurality of displays is different depending on a user (a radiological technician, a doctor, or the like) of the display or a purpose of the image reading (single image reading, comparative image reading, electronic medical chart editing, or the like).

When a medical image is displayed on a display, an optimum gradation characteristic is different according to a type of the medical image. For example, in the case of a tomographic image captured by a CT or an MRI, it is desirable to use a gradation characteristic referred to as a grayscale standard display function (GSDF) of digital imaging and communication in medicine (DICOM) (hereinbelow, referred to as “DICOM gradation”). Further, in the case of a color image like an endoscopic image, it is desirable to use a gradation characteristic with a common gamma value 2.2 (hereinbelow, referred to as “gamma 2.2 gradation”).

However, a conventional display system cannot recognize which display displays which medical image. Thus, a user needs check a currently using gradation characteristic by displaying it on a display by on-screen display (OSD) display to set a gradation characteristic appropriate for a medical image to be displayed and operate switching button on a display main body to switch the gradation characteristic. There is an issue that frequently switching the gradation characteristic of the display is troublesome for a user and decreases effectiveness of the diagnostic imaging.

In addition, if a user needs to switch the gradation characteristic, the user may forget to switch the gradation characteristic or make a mistake in choosing the gradation characteristic to use. If the switch of the gradation characteristic is not performed appropriately, display quality of a medical image is deteriorated. Accordingly, there is an issue that a user may overlook an affected area (a tumor, a calcification portion, and the like) in a medical image or make a wrong diagnosis.

### SUMMARY

In order to solve the above-described issue, a display control apparatus according to aspects of the present invention for controlling gradation characteristics of a plurality of display apparatuses displaying read images includes an obtaining unit configured to obtain image reading area information indicating a display area of the read image and image type information indicating a type of the read image, a specifying unit configured to specify, based on the image reading area information, one or more display apparatuses displaying the read images among the plurality of display apparatuses, and a setting unit configured to set gradation characteristics of the one or more display apparatuses specified by the specifying unit to gradation characteristics corresponding to the image type information.

Further features of the present disclosure will become apparent from the following description of exemplary embodiments with reference to the attached drawings.

### BRIEF DESCRIPTION OF THE DRAWINGS

FIGS. 1A and 1B illustrate a display system 1 according to a first exemplary embodiment.

FIGS. 2A and 2B illustrate a plurality of types of gradation characteristics.

FIG. 3 illustrates configurations of a display control apparatus 10 and a display 30.

FIG. 4 illustrates an example of a screen configuration to be displayed on displays 30L, 30C, and 30R.

FIG. 5 is a flowchart illustrating operations of the display control apparatus 10 to change a gradation mode.

FIG. 6 is a flowchart illustrating operations of the display 30 to change a gradation mode.

FIGS. 7A and 7B illustrate examples of a screen configuration according to a second exemplary embodiment.

FIG. 8 is a flowchart illustrating operations of the display control apparatus 10 according to the second exemplary embodiment to change a gradation mode.

FIG. 9 is a flowchart illustrating operations of the display 30 according to the second exemplary embodiment to change a gradation mode.

FIG. 10 illustrates a configuration of a display system 1 according to a third exemplary embodiment.

FIG. 11 is a table indicating examples of gradation characteristics managed by a gradation mode management unit 320.

FIG. 12 illustrates an example of a screen configuration in which images for comparative image reading are displayed on a display 31C and a display 31R.

FIG. 13 is a flowchart illustrating operations of a display control apparatus 11 according to the third exemplary embodiment.

FIG. 14 is a flowchart illustrating operations of a comparative image reading determination unit 240 to determine whether a read image is an image for single image reading or an image for comparative image reading.

FIG. 15 illustrates a configuration of a display system 1 according to a fourth exemplary embodiment.

FIG. 16 is a flowchart illustrating operations of a display control apparatus 12 according to the fourth exemplary embodiment to set a new gradation characteristic to a display 32.

FIG. 17 is a flowchart illustrating operations of the display 32 according to the fourth exemplary embodiment to calculate a gradation correction value.

### DESCRIPTION OF THE EMBODIMENTS

### [Outline of Display System 1]

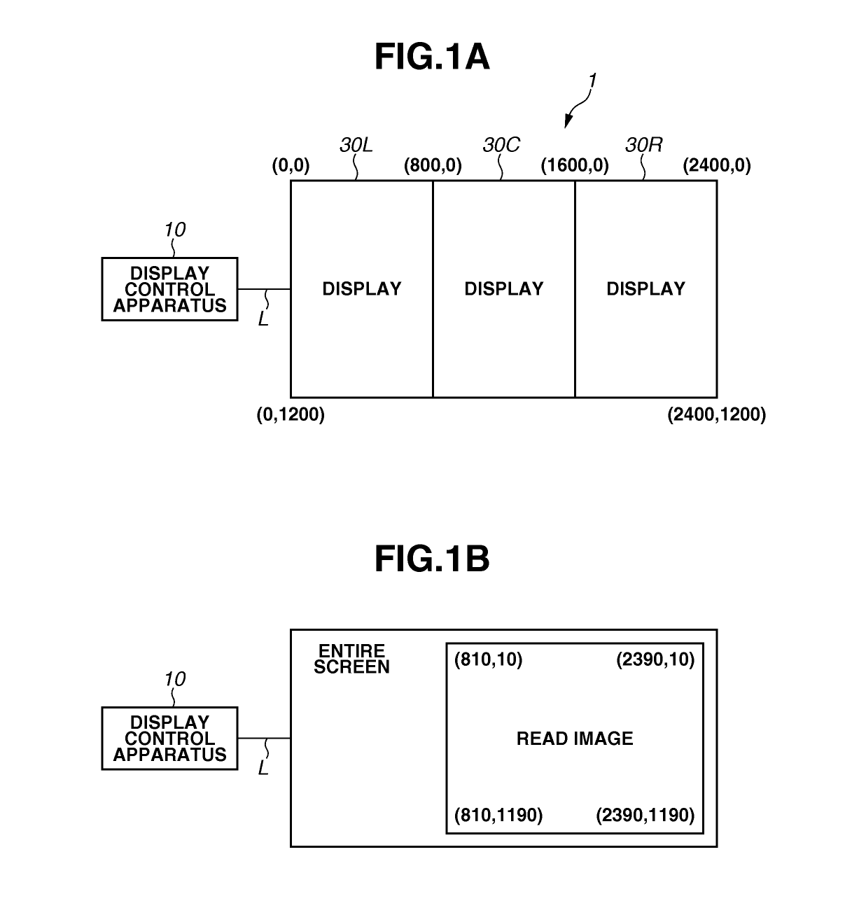

FIGS. 1A and 1B illustrate a display system 1 according to a first exemplary embodiment. FIG. 1A schematically illustrates a configuration of the display system 1. The display system 1 includes a plurality of displays 30 (displays 30L, 30C, and 30R) and a display control apparatus 10 controlling the plurality of displays 30. The display control apparatus 10 and each display 30 are connected to each other by a communication line L, such as a universal serial bus (USB) cable. The display control apparatus 10 transmits image information to be displayed on the display 30 and control information for controlling the display 30 to each display 30 via the communication line L.

Each display 30 includes 800*1200 pixels. The display system 1 includes three displays 30 arranged adjacent to each other, so that an entire screen including 2400*1200 pixels is constituted. Each pixel in the entire screen is expressed by coordinates which has coordinates (0, 0) on an upper left position as a reference. As illustrated in FIG. 1A, a lower left position has coordinates (0, 1200), an upper right position has coordinates (2400, 0), and a lower right position has coordinates (2400, 1200).

The display control apparatus 10 is a computer which controls gradation characteristics of the displays 30. The display control apparatus 10 can execute a medical image display application (hereinbelow, referred to as the “display application”) for enabling a user to select an image to be displayed on the display 30 and to adjust a layout of a drawing area of the image to be displayed on the display 30. A user can adjust an area to display a read image included in a medical image as a target of image reading (hereinbelow, referred to as an “image reading area”) using the display application. A medical image includes a read image and a non-read image which is an image and a text other than a read image.

FIG. 1B schematically illustrates a state in which a read image is displayed on the displays 30C and 30R. The display application generates coordinate information indicating coordinates of an image reading area based on a position on which a user arranges a read image. In the example illustrated in FIG. 1B, the image reading area is specified by coordinates of four corners, namely (810, 10), (810, 1190), (2390, 10), and (2390, 1190).

The display control apparatus 10 specifies which display 30 the image reading area is displayed on among three displays 30 based on the coordinates of four corners of the image reading area. In addition, the display control apparatus 10 sets gradation characteristics of one or more specified displays 30 based on a type of the read image to be displayed in the image reading area. More specifically, the display control apparatus 10 instructs the display 30 displaying the read image to display the read image in a gradation mode to which the gradation characteristic according to the type of the read image is applied. When receiving the instruction from the display control apparatus 10, the display 30 displaying the read image corrects the gradation characteristic currently applying to the gradation characteristic corresponding to the gradation mode instructed by the display control apparatus 10 and displays the read image using the corrected gradation characteristic.

The gradation characteristic is a relationship between a gradation of an image input to the display 30 (an input gradation) and a gradation of brightness of a display screen (a display gradation).

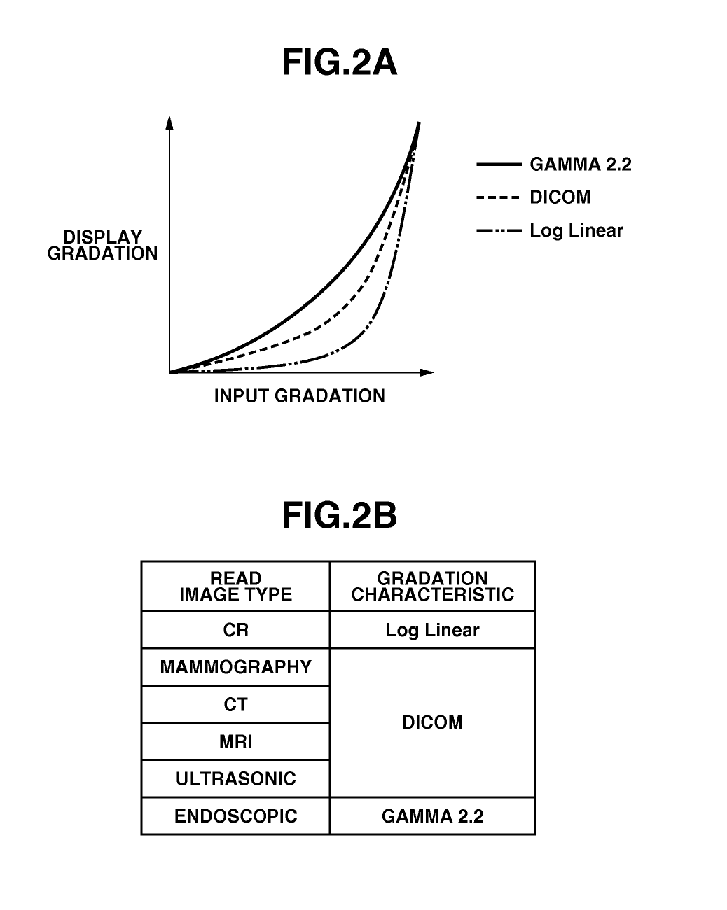

FIGS. 2A and 2B indicate a plurality of gradation characteristic types. FIG. 2A illustrates a relationship between an input gradation and a display gradation of a plurality of gradation characteristics. The gradation characteristics used in the present exemplary embodiment are a gamma 2.2 gradation, a DICOM gradation, and a Long Linear gradation. When the input gradation is defined as INn, and the display gradation is defined as Ln in the case that the gradation characteristic is the gamma 2.2 gradation, the display gradation will be a curve expressed by Ln=(INn/INmax)^{2.2}*Lmax. Here, INmax represents a maximum value of the input gradation, and Lmax represents a maximum value of the display gradation. The Long Linear gradation is a gradation characteristic used for displaying an image similarly to when an X-ray film is displayed.

FIG. 2B is a table indicating a relationship between a type of a read image and a gradation characteristic appropriate for each read image. The Long Linear gradation is appropriate for a computed radiography (CR) image, the DICOM gradation is appropriate for a mammographic image, a CT image, an MRI image, and an ultrasonic image, and the gamma 2.2 gradation is appropriate for an endoscopic image. The display control apparatus 10 sets the gradation characteristic of the display 30 displaying the read image to the gradation characteristic selected based on the type of the read image and thus can improve diagnostic accuracy using the read image.

Configurations and operations of the display control apparatus 10 and the displays 30 are described in detail below.

### [Configurations of Display Control Apparatus 10 and Display 30]

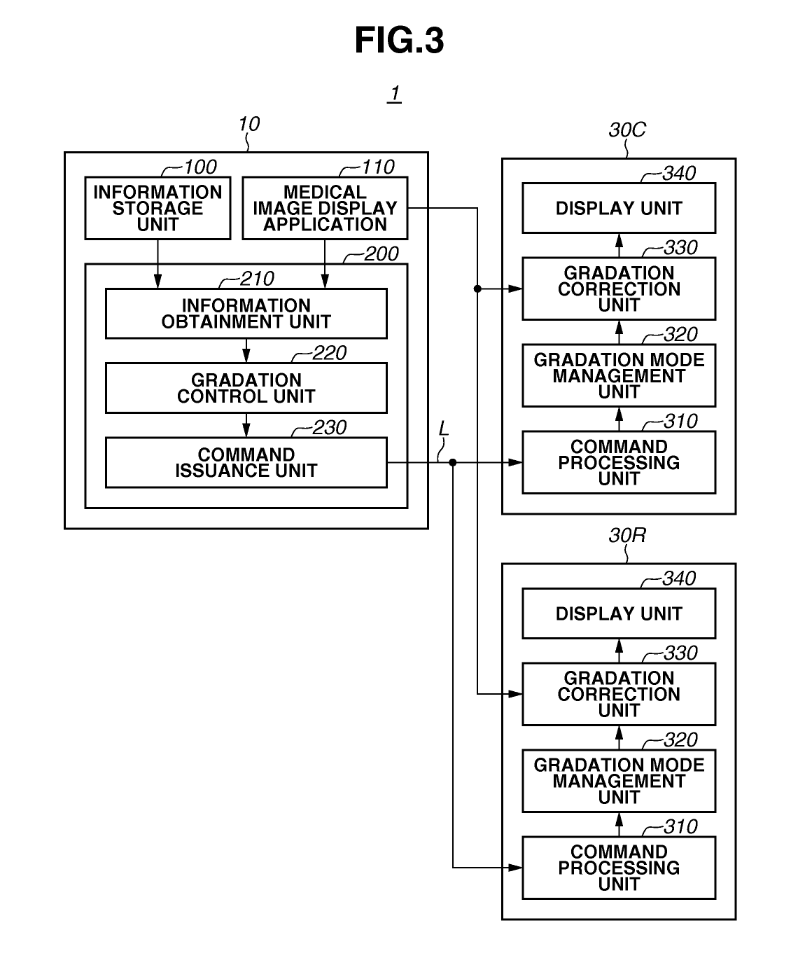

FIG. 3 illustrates the configurations of the display control apparatus 10 and the display 30. In the configuration illustrated in FIG. 3, the display control apparatus 10 is connected to the display 30C and the display 30R, however, an arbitrary number of the displays 30 can be connected to the display control apparatus 10.

The display control apparatus 10 includes an information storage unit 100 and a control unit 200. In addition, a display application 110 for displaying a medical image is installed in the display control apparatus 10. The information storage unit 100 includes a memory for storing various types of information pieces and stores information indicating the relationship between the type of the read image and the gradation characteristics shown in FIG. 2B. The information storage unit 100 also stores display information regarding the display 30 connected to the display control apparatus 10.

The display information includes at least entire screen information (a width, a height, and arrangement) regarding the entire screen constituted by all of the running displays 30, size information (a width and a height) indicating a screen size of each display, and information (upper left coordinates, a width, and a height in the entire screen) indicating a drawing area of each running application. The information storage unit 100 obtains the display information via an operating system of the display control apparatus 10. The information storage unit 100 updates the display information every time when a running state of the display 30 or a running state of an application is changed.

The display application 110 forms a display screen by arranging various medical images in response to a diagnostic purpose and supplies an image signal to the display 30 via a display driver. The display application 110 is stored in a storage medium, such as a read-only memory (ROM) and a hard disk, and functions as a medical image viewer by being executed by the control unit 200.

The display application 110 forms an operation screen for selecting a read image to be a display target, an image reading screen for displaying the read image for diagnosis, and other screens based on a user operation. The display application 110 supplies image reading screen information to the control unit 200 at a timing when the image reading screen is displayed on the display 30. The image reading screen information includes image reading area information indicating a position of the image reading area in the entire screen and image type information indicating a type of the read image. The image reading area information includes information indicating the upper left coordinates, the width, and the height of the image reading area. The image type information include information for specifying a type of an image, such as a tomographic image and an endoscopic image. The display application 110 supplies the image reading screen information to the control unit 200 every time a user newly displays an image reading screen or changes a display position of the read image in the image reading screen.

The control unit 200 includes a central processing unit (CPU) and functions as an information obtaining unit 210, a gradation control unit 220, and a command issuance unit 230. In addition, the control unit 200 can execute the display application 110 and a display control program stored in the storage medium, such as the ROM and the hard disk.

The information obtaining unit 210 obtains the image reading screen information including the image reading area information and the image type information from the display application 110. The information obtaining unit 210 also obtains the size information indicating the screen sizes of the plurality of displays 30 and the display information including information regarding arrangement of the plurality of displays 30 from the information storage unit 100. The information obtaining unit 210 supplies these obtained information pieces to the gradation control unit 220. The information obtaining unit 210 may obtain the image reading area information, the image type information, the size information, and the entire screen information from outside of the display control apparatus 10.

The gradation control unit 220 receives the image reading screen information from the display application 110 and the display information from the information storage unit 100 via the information obtaining unit 210. The gradation control unit 220 specifies one or more displays 30 displaying the read image based on the size information and arrangement information included in the display information and the image reading area information included in the image reading screen information. More specifically, the gradation control unit 220 generates coordinate information of the entire screen constituted by the plurality of displays 30 based on the size information and the arrangement information and specifies the display 30 displaying the read image based on the generated coordinate information and the image reading area information. Further, the gradation control unit 220 determines the gradation mode corresponding to the gradation characteristic when the read image is displayed on the display 30 based on the image type information received from the display application 110.

The command issuance unit 230 creates a command to control display characteristics, such as the gradation characteristic, brightness (luminance), and a color temperature of the display 30, and transmits the display control command to the display 30 via the communication line L, such as a USB cable. The command issuance unit 230 transmits the display control command in response to an instruction from the gradation control unit 220 at the time of startup of the display application 110, a shift of a screen, a change in display position of the read image, execution of a display calibration tool, and the like.

For example, when the gradation control unit 220 determines the gradation mode of the display 30 displaying the read image in response to the change in the display position of the read image, the command issuance unit 230 transmits a gradation mode change command to the display 30 displaying the read image as the display control command. Since the command issuance unit 230 transmits the gradation mode change command, the gradation characteristic of the display 30 displaying the read image can be set to the gradation characteristic appropriate for the read image displayed on the display 30. The gradation mode change command includes at least command identification information for enabling the display 30 which received the command to specify a command type and gradation mode type information for enabling the display 30 to specify the changed gradation mode.

The configuration of the display 30 is described below. The display 30 includes a command processing unit 310, a gradation mode management unit 320, a gradation correction unit 330, and a display unit 340.

The command processing unit 310 analyzes the display control command received from the command issuance unit 230 and issues an instruction to a function block which executes display control processing based on the display control command. When the command processing unit 310 recognizes that the received display control command is the gradation mode change command based on the command identification information included in the display control command, the command processing unit 310 issues, to the gradation mode management unit 320, an instruction to change the gradation mode to the one corresponding to the gradation mode type information included in the gradation mode change command.

The gradation mode management unit 320 stores a gradation correction value by associating with a type of the gradation mode. In addition, the gradation mode management unit 320 stores a type of the gradation mode currently applied. When the gradation mode change instruction is received from the command processing unit 310, the gradation mode management unit 320 obtains the gradation correction value associated with the type of the gradation mode. The gradation mode management unit 320 sets the obtained gradation correction value to the gradation correction unit 330.

The gradation correction value is a value defining an output gradation OUTn for obtaining the display gradation Ln corresponding to the input gradation INn. As described above, when the display characteristic of the display is the gamma 2.2 gradation, the display gradation will be a curve expressed by Ln=(INn/INmax)^{2.2}*Lmax. The output gradation OUTn is obtained by multiplying the display gradation Ln by a reverse display characteristic of the display. Thus, the output gradation is expressed as OUTn=(Ln/Lmax)^{1/2.2}*OUTmax. Therefore, when the type of the gradation mode is the gamma 2.2 gradation, a relational expression INn=OUTn*(INmax/OUTmax) is obtained by substituting Ln=(INn/INmax)^{2.2}*Lmax for OUTn=(Ln/Lmax)^{1/2.2}*OUTmax. The gradation correction value as described above is calculated using a factory shipment adjustment tool for the display 30, and a medical display management tool, the display calibration tool, and the like executable by the display control apparatus 10 or the display 30.

The gradation correction unit 330 corrects a gradation value of the read image input from the display control apparatus 10 based on the gradation correction value. When the gradation correction value corresponding to the changed gradation mode is received from the gradation mode management unit 320, the gradation correction unit 330 changes the gradation correction value currently applied to the received gradation correction value. The gradation correction unit 330 supplies a read image a gradation value of which is corrected based on the changed gradation correction value to the display unit 340.

The display unit 340 includes, for example, a liquid crystal panel and a backlight. The display unit 340 displays the read image supplied from the gradation correction unit 330. The read image supplied from the gradation correction unit 330 is corrected based on the gradation characteristic appropriate for the type of the read image, so that the display unit 340 can display the read image in a state appropriate for image reading.

### [Operations of Display Control Apparatus 10 and Display 30]

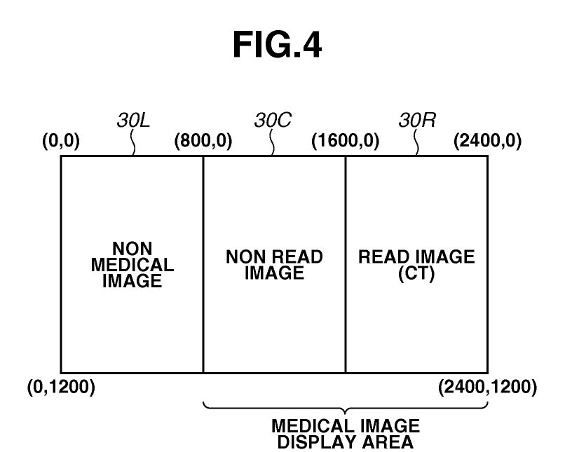

FIG. 4 illustrates an example of a screen configuration displayed on the displays 30L, 30C, and 30R. In the example illustrated in FIG. 4, medical images output from the display application 110 are displayed on the display 30C in the center and the display 30R on the right among the three displays 30. The display information stored in the information storage unit 100 includes information pieces which are the entire screen information as (width=2400, height=1200, arrangement=the displays 30L, 30C, and 30R), the size information of each display as (width=800, height=1200), and drawing area information of a medical image as (upper left coordinates=(800, 0), width=1600, height=1200).

In addition, the display area of the display 30L is expressed as (upper left coordinates=(0, 0), width=800, height=1200), the display area of the display 30C is expressed as (upper left coordinates=(800, 0), width=800, height=1200), and the display area of the display 30R is expressed as (upper left coordinates=(1600, 0), width=800, height=1200). Since a medical image drawing area is expressed as (upper left coordinates=(800, 0), width=1600, height=1200), the gradation control unit 220 specifies that the display 30C and the display 30R display medical images.

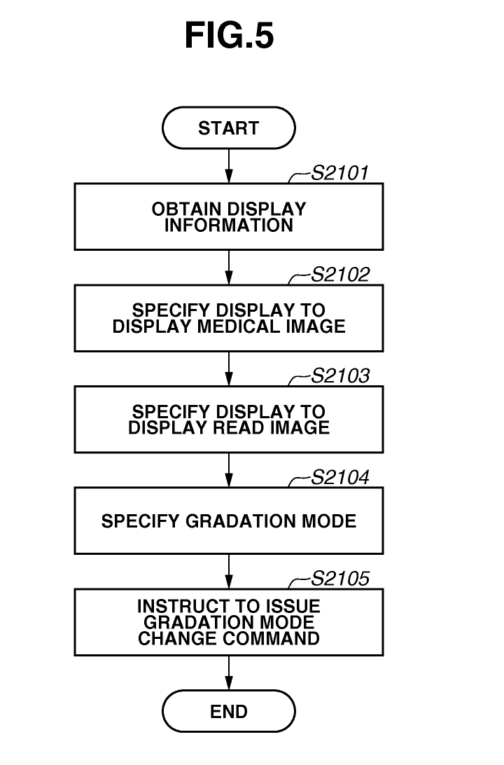

FIG. 5 is a flowchart illustrating operations of the display control apparatus 10 to change the gradation mode of the display 30. More specifically, FIG. 5 illustrates operations for setting the gradation characteristic that the gradation control unit 220 executes when receiving the image reading screen information from the display application 110.

First, in step S2101, when the image reading screen information is received in response to a change in the display area of the read image, the gradation control unit 220 obtains the display information from the information storage unit 100. In step S2102, the gradation control unit 220 specifies the display 30 displaying a screen of the display application 110 based on the entire screen information included in the display information, the size information of the respective displays 30, and the drawing area information of the display application 110.

Next, in step S2103, the gradation control unit 220 specifies the display 30 displaying the read image based on the image reading area information indicating the display area of the read image included in the image reading screen information. In the example illustrated in FIG. 4, an area of the read image in the medical images is expressed as (upper left coordinates=(800, 0), width=800, height=1200). Since the drawing area of the medical image is expressed as (upper left coordinates=(800, 0), width=1600, height=1200), the gradation control unit 220 specifies that the image reading area is expressed as (upper left coordinates=(1600, 0), width=800, height=1200) and the display 30R displays the read image.

In step S2104, the gradation control unit 220 specifies the gradation mode used by the display 30R displaying the read image based on the image type information included in the image reading screen information. In the example illustrated in FIG. 4, since a type of the read image is CT, the gradation control unit 220 specifies the gradation mode as the DICOM gradation mode based on the information indicating the correspondence between a medical image type and the gradation characteristic shown in FIG. 2B.

Next, in step S2105, the gradation control unit 220 issues, to the command issuance unit 230, a command issuance instruction to change the gradation characteristic of the specified display 30R to the specified gradation characteristic. The gradation mode change command issuance instruction includes at least display identification information for specifying the display 30 as a target of a gradation mode change and the gradation mode type information indicating the type of the gradation mode. In the case of the example illustrated in FIG. 4, the command issuance unit 230 transmits to the display 30R the gradation mode change command instructing the display 30R to change the gradation mode to the DICOM gradation mode based on the instruction received from the gradation control unit 220.

### [Operations of Display 30]

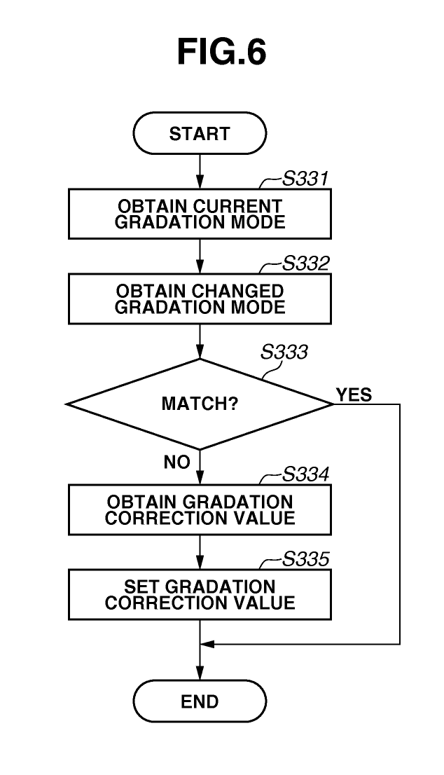

Processing by the gradation mode management unit 320 to change the gradation mode is described below. FIG. 6 is a flowchart illustrating operations of the display 30 to change the gradation mode.

When the gradation mode change instruction is received from the command processing unit 310, the gradation mode management unit 320 starts gradation mode change processing. In step S331, when the gradation mode change instruction is received, the gradation mode management unit 320 obtains the type of the gradation mode currently applied from an internal memory. In step S332, the gradation mode management unit 320 further obtains the type of the gradation mode included in the gradation mode change instruction. Then, in step S333, the gradation mode management unit 320 determines whether the type of the gradation mode to be changed matches with the type of the gradation mode currently applied.

If the type of the gradation mode to be changed matches with the type of the gradation mode currently applied (YES in step S333), it is not necessary to change the gradation mode, and the gradation mode management unit 320 terminates the gradation mode change processing. If the type of the gradation mode to be changed does not match with the type of the gradation mode currently applied (NO in step S333), in step S334, the gradation mode management unit 320 obtains a gradation correction value corresponding to the type of the gradation mode to be changed. Then, in step S335, the gradation mode management unit 320 sets the obtained gradation correction value to the gradation correction unit 330. In the example illustrated in FIG. 4, the type of the changed gradation mode is the DICOM gradation, and if the type of the gradation mode currently applied is the gamma 2.2 gradation, the gradation characteristic is changed from the gamma 2.2 gradation to the DICOM gradation. If the gradation mode is changed from the gamma 2.2 gradation to the DICOM gradation, an intermediate gradation is darkly displayed as a whole as illustrated in FIG. 2A.

### [Effect According to First Exemplary Embodiment]

As described above, the display control apparatus according to the first exemplary embodiment specifies the display 30 which displays a read image at a timing when a medical image is displayed or moved and sets the gradation characteristic appropriate for a type of the read image. In addition, the display 30 displaying the read image changes the gradation characteristic to display the read image based on the gradation characteristic set by the display control apparatus 10. Accordingly, in the display system 1, the display 30 can display the read image based on the gradation characteristic appropriate for the read image without a special operation by a user.

### [Displaying a Plurality of Types of Read Images]

According to the first exemplary embodiment, one type of the read image is displayed on the display 30, however, a second exemplary embodiment is different from the first exemplary embodiment at a point that two or more types of read images are displayed on the display 30. The configurations of the display control apparatus 10 and the displays 30 illustrated in FIG. 3 are the same in the second exemplary embodiment.

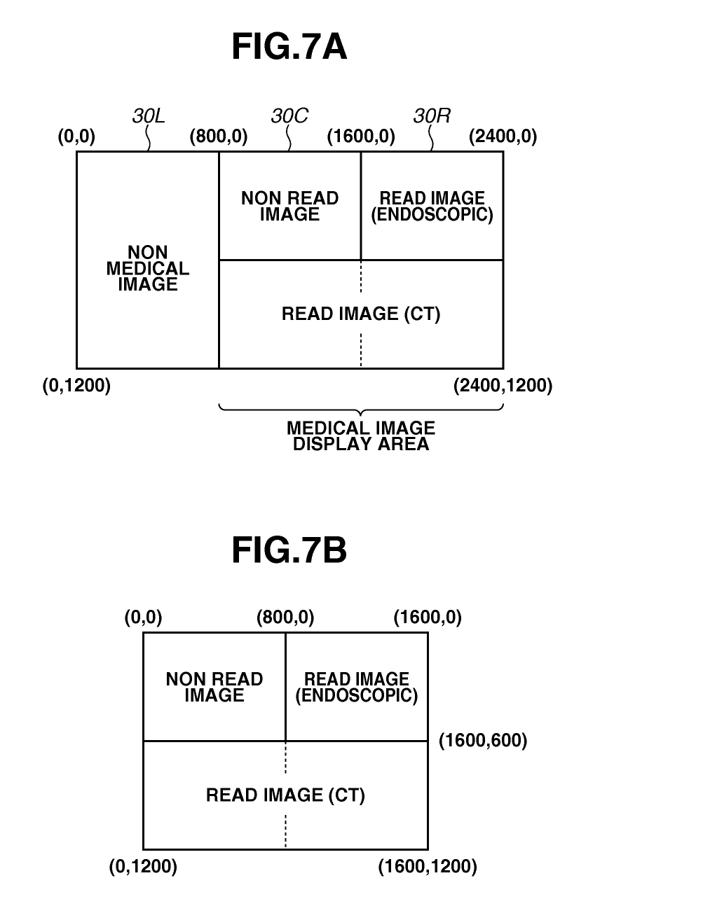

FIGS. 7A and 7B illustrate examples of a screen configuration of the displays 30 according to the second exemplary embodiment. FIG. 7A illustrates an entire screen, and FIG. 7B illustrates areas in which medical images are displayed by the display application 110. As illustrated in FIGS. 7A and 7B, according to the second exemplary embodiment, an endoscopic image and a CT image are displayed on the displays 30C and 30R as read images.

As illustrated in FIG. 7A, a display area (upper left coordinates, width, and height) of the medical images is expressed as ((800, 0), 1600, 1200) in the entire screen. As illustrated in FIG. 7B, an image reading screen area of the endoscopic image on a screen of the display application 110 is expressed as ((800, 0), 800, 600), and an image reading screen area of the CT image is expressed as ((600, 0), 1600, 600). In addition, an area of the display 30L is expressed as ((0, 0), 800, 1200), an area of the display 30C is expressed as ((800, 0), 800, 1200), and an area of the display 30R is expressed as ((1600, 0), 800, 1200) in the entire screen.

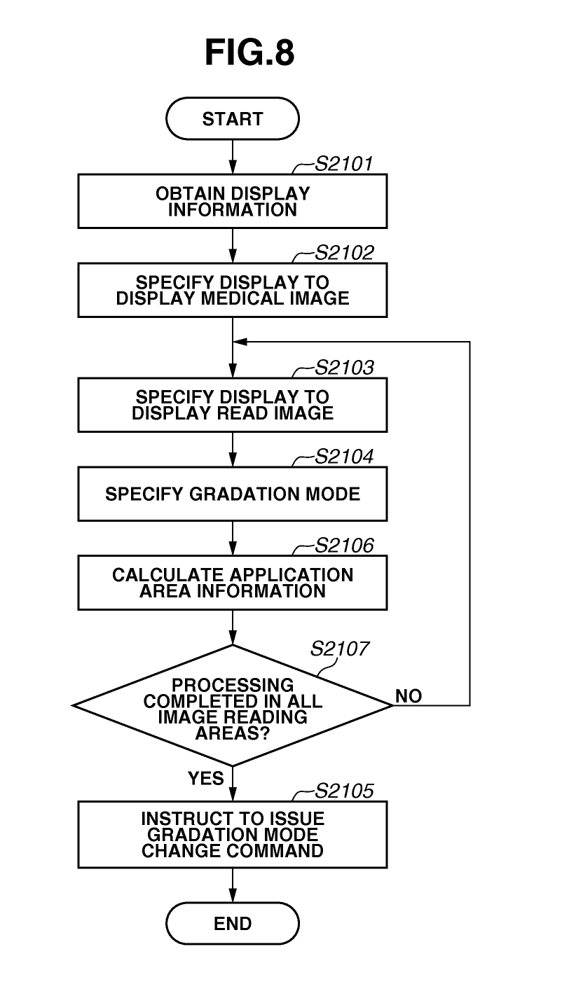

FIG. 8 is a flowchart illustrating operations of the display control apparatus 10 according to the second exemplary embodiment to change the gradation mode. The operations in step S2101 to step S2104 in FIG. 8 are same as those according to the first exemplary embodiment in FIG. 5, and thus detailed descriptions thereof are omitted.

When the image reading screen information is received from the display application 110, the gradation control unit 220 starts processing for controlling the gradation characteristics of the image reading areas. The image reading screen information includes at least the number of the image reading areas and the image reading screen information and the image type information corresponding to each image reading area. The gradation control unit 220 specifies that the displays displaying images by the display application 110 are the displays 30C and 30R by the processing in step S2102 described with reference to FIG. 5.

Further, the gradation control unit 220 specifies that the display displaying the endoscopic image is the display 30R and the displays displaying the CT image are the displays 30C and 30R by the processing in step S2103 described with reference to FIG. 5. Furthermore, the gradation control unit 220 specifies that the type of the gradation mode on an upper half of the display 30R is the gamma 2.2 gradation and the type of the gradation mode on lower halves of the displays 30C and 30R is the DICOM gradation by the processing in step S2104 described with reference to FIG. 5.

Next, in step S2106, the gradation control unit 220 calculates application area information (upper left coordinates, width, and height) indicating the area of the read image to which the gradation mode is applied based on a layout of the image reading screen indicated by the image reading screen information. In the example illustrated in FIGS. 7A and 7B, the gradation control unit 220 calculates the application area information as ((0, 0), 800, 600) which indicates the area in which the gamma 2.2 gradation mode for the endoscopic image is applied to the display 30R based on the information ((800, 0), 800, 600) indicating the area displaying the endoscopic image and the size information (width 800 and height 1200) of the display 30R. Further, the gradation control unit 220 calculates the application area information as ((0, 600), 800, 600) which indicates the area in which the DICOM gradation mode for the CT image is applied to each of the displays 30C and 30R based on the information ((0, 600), 1600, 600) indicating the area displaying the CT image and the size information (width 800 and height 1200) of the displays 30C and 30R.

Then, in step S2107, the gradation control unit 220 determines whether specification of the displays 30 displaying the read images corresponding to the number of the image reading areas indicated by the image reading screen information, specification of the type of the gradation mode, and calculation of the application area information are completed. If these specification processes are not completed yet (NO in step S2107), in step S2103, the gradation control unit 220 specifies the display displaying the read image with respect to a next image reading area. If these specification processes are completed in all of the image reading areas (YES in step S2107), in step S2105, the gradation control unit 220 instructs the command issuance unit 230 to issue the gradation mode change command.

The instruction to issue the gradation mode change command according to the present exemplary embodiment includes at least the display identification information, the gradation mode type information, and the application area information. In addition, the gradation mode change command issued by the command issuance unit 230 includes at least the command identification information, the gradation mode type information, and the application area information. In the example illustrated in FIGS. 7A and 7B, the command issuance unit 230 transmits to the display 30C a command to change the gradation mode of the lower half of the display 30C to the DICOM gradation mode and transmits to the display 30R a command to change the gradation mode of the upper half of the display 30R to the gamma 2.2 gradation and a command to change the gradation mode of the lower half of the display 30R to the DICOM gradation mode.

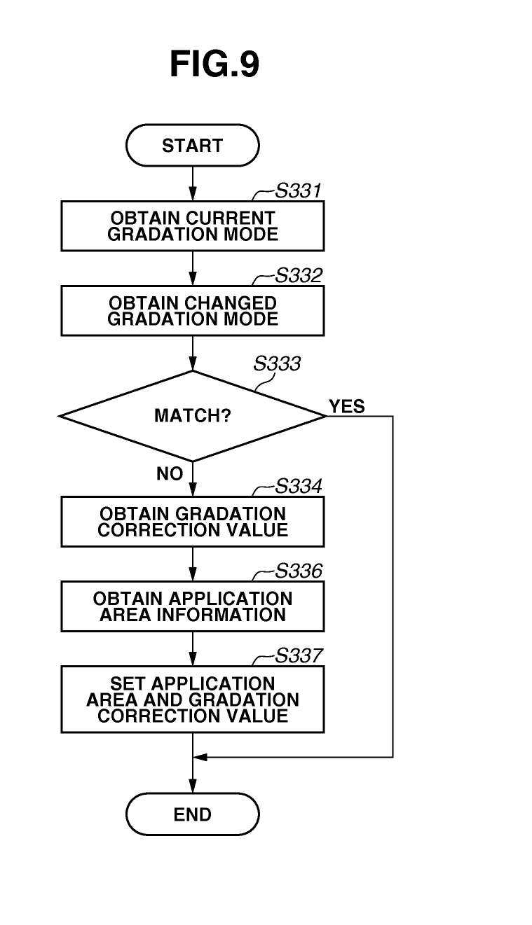

FIG. 9 is a flowchart illustrating operations of the display 30 which received the gradation mode change command to change the gradation mode when. When the gradation mode change instruction is received from the command processing unit 310, the gradation mode management unit 320 starts the gradation mode change processing. The gradation mode change instruction includes at least the gradation mode type information and the application area information. The processing in step S331 to step S334 in FIG. 9 is same as that in FIG. 6, and thus descriptions thereof are omitted.

In step S336, the gradation mode management unit 320 obtains the application area information included in the gradation mode change instruction. Then, in step S337, the gradation mode management unit 320 sets an area as a target of the gradation correction and a gradation correction value to the gradation correction unit 330 based on the gradation mode type information and the application area information. In the example illustrated in FIGS. 7A and 7B, the gradation mode management unit 320 of the display 30C sets the gradation correction value for setting the DICOM gradation mode to the lower half area. The gradation mode management unit 320 of the display 30R sets the gradation correction value for setting the gamma 2.2 gradation mode to the upper half area and the gradation correction value for setting the DICOM gradation mode to the lower half area.

If the type of the gradation mode before changing the gradation mode is the gamma 2.2 gradation in the displays 30C and 30R, the gradation characteristic is not changed in the upper half of the display 30R. The gradation characteristic is changed in the lower half of the display 30C and the display 30R.

The gradation correction unit 330 selects a gradation correction value corresponding to the image reading area if a display area of an input image signal matches with the image reading area, and selects a normal gradation correction value if a display area of an input image signal does not match with the image reading area, and in this manner, the gradation correction unit 330 changes a gradation characteristic of an output image signal according to the display area. In the example illustrated in FIGS. 7A and 7B, the gradation correction units 330 of the displays 30C and 30R apply a correction value of the DICOM gradation instead of a normal correction value of the gamma 2.2 gradation when the display area of the input image signal is the lower half area.

### [Effect According to Second Exemplary Embodiment]

As described above, the display control apparatus according to the second exemplary embodiment sets the gradation characteristic of the area displaying the read image to the gradation characteristic appropriate for each read image when a plurality of read images of different types are displayed on the plurality of displays 30. In addition, the display 30 sets a gradation correction value of the area displaying the read image to a value corresponding to the gradation characteristic appropriate for the displayed read image. Accordingly, the gradation characteristic of each area displaying the read image can be set to the appropriate gradation characteristic without a special operation by a user.

### [Using Gradation Mode for Comparative Image Reading]

According to the first exemplary embodiment, it is assumed that a read image is solely subjected to image reading, however, a third exemplary embodiment is different from the first exemplary embodiment at a point that it is assumed that comparative image reading is performed in which a plurality of read images is compared.

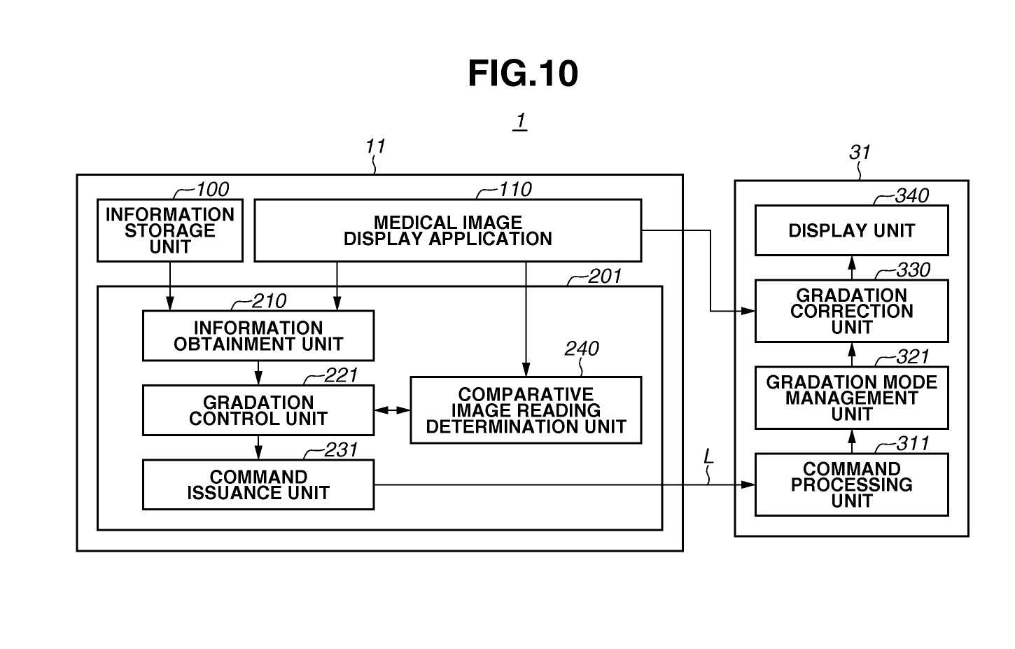

FIG. 10 illustrates a configuration of a display system 1 according to the third exemplary embodiment. The display system 1 illustrated in FIG. 10 is different at the point that a display control apparatus 11 and a display 31 are included instead of the display control apparatus 10 and the display 30 illustrated in FIG. 3. The display control apparatus 11 includes a control unit 201 instead of the control unit 200 in the display control apparatus 10 illustrated in FIG. 3. The control unit 201 is different from the control unit 200 at a point that a comparative image reading determination unit 240 is further included. In addition, the control unit 201 includes a gradation control unit 221 and a command issuance unit 231 respectively instead of the gradation control unit 220 and the command issuance unit 230.

The display 31 is different from the display 30 at points that the display 31 includes a command processing unit 311 and a gradation mode management unit 321 respectively instead of the command processing unit 310 and the gradation mode management unit 320.

When a user performs comparative image reading using a plurality of displays 31, and if the plurality of displays 31 does not display read images based on the same gradation characteristic, accuracy of the comparative image reading is lowered. Thus, the display system 1 according to the present exemplary embodiment is different from the display system 1 according to the first exemplary embodiment at a point that the plurality of displays 31 uses a gradation characteristic for comparative image reading so that a plurality of read images to be compared with each other is displayed based on the same gradation characteristic. According to the present exemplary embodiment, a read image when a user does not perform the comparative image reading using the plurality of displays 31 is referred to as an image for single image reading, a read image when a user perform the comparative image reading using the plurality of displays 31 is referred to as an image for comparative image reading.

The configurations and operations different from those according to the first exemplary embodiment are described below.

When image reading screen information is received from the display application 110 via the information obtaining unit 210, the gradation control unit 221 specifies the plurality of displays 31 displaying the read images and also specifies the gradation mode applied to the plurality of specified displays 31. The gradation control unit 221 supplies a comparative image reading determination instruction to determine whether the read image is an image for single image reading or an image for comparative image reading to the comparative image reading determination unit 240. The comparative image reading determination instruction includes the display identification information of the plurality of displays 31 displaying the read images and the image type information of the read image displayed on each display 31.

When the comparative image reading determination instruction is received from the gradation control unit 221, the comparative image reading determination unit 240 determines whether the read image is an image for comparative image reading or an image for single image reading. If the type of the read image to be displayed on each of the plurality of displays 31 is different from each other, the comparative image reading determination unit 240 determines that the read image is an image for single image reading. If the type of the read image to be displayed on each of the plurality of displays 31 is the same with each other, the comparative image reading determination unit 240 determines that the read image is an image for comparative image reading. The comparative image reading determination unit 240 notifies the gradation control unit 221 of a determination result.

When the determination result of whether the plurality of displays 31 displays an image for single image reading or an image for comparative image reading is received from the comparative image reading determination unit 240, the gradation control unit 221 outputs, to the command issuance unit 231, a command issuance instruction to issue the gradation mode change command to the display displaying the read image. The command issuance instruction includes at least the display identification information, the gradation mode type information, a comparative image reading flag, and information regarding an adjacency condition (hereinbelow, referred to as “adjacency condition information”). The adjacency condition information includes the display identification information of another adjacent display 31 among the plurality of displays 31. The comparative image reading flag is information indicating whether the read image is an image for comparative image reading.

The command issuance unit 231 creates a display control command based on the command issuance instruction received from the gradation control unit 221 and transmits the created command to the displays 31 via the communication line L, such as a USB cable. More specifically, when the command issuance instruction is received from the gradation control unit 221, the command issuance unit 231 creates a gradation mode change command and transmits the created command to the command processing units 311 of the displays 31 displaying a plurality of the read images. The gradation mode change command includes at least the command identification information, the gradation mode type information, the comparative image reading flag, and the adjacency condition information.

When the command processing unit 311 recognizes that the display control command received from the command issuance unit 231 is a command instructing a change of the gradation mode, the command processing unit 311 issues the gradation mode change instruction to a gradation mode management unit 321. The gradation mode change instruction includes at least the type of the gradation mode, the comparative image reading flag, and the adjacency condition information.

The gradation mode management unit 321 manages the gradation mode when an image for single image reading is displayed and the gradation mode when an image for comparative image reading is displayed for each type of the read image. In addition, the gradation mode management unit 321 manages a gradation mode for comparative image reading associated with an adjacent display 31 displaying an image for comparative image reading as a gradation mode when an image for comparative image reading is displayed. A gradation characteristic for comparative image reading is used in the gradation mode for comparative image reading. In the gradation characteristic for comparative image reading, a gradation correction value is applied so as to match display gradations (minimum brightness to maximum brightness) of two adjacent displays 31 with each other. The gradation correction value is calculated in advance using a medical display management tool and a display calibration tool executable by the display control apparatus 11 or the display 31.

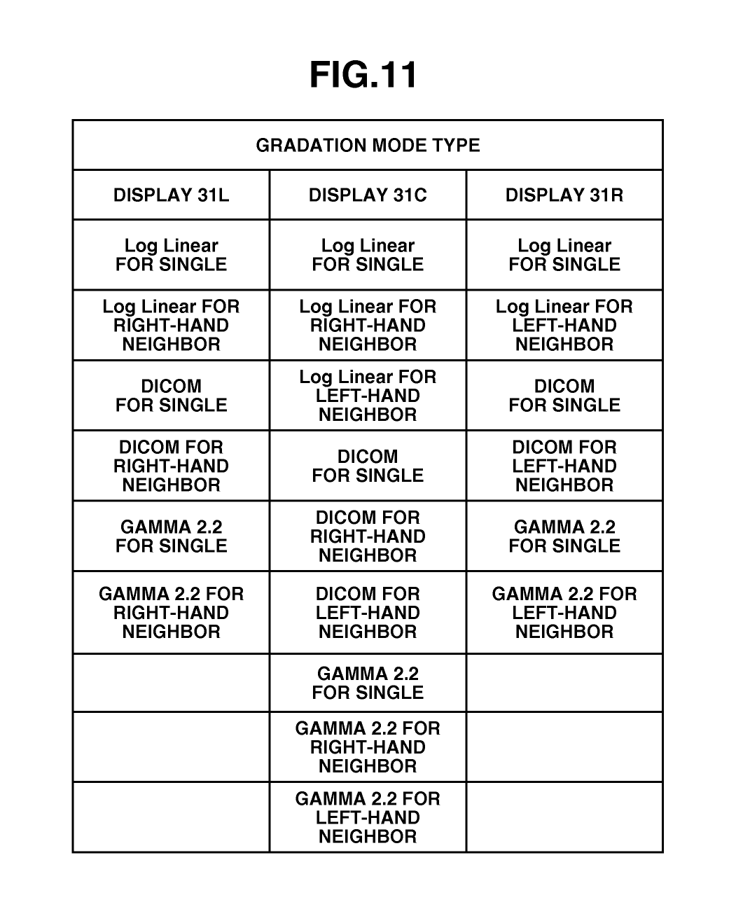

FIG. 11 is a table indicating examples of the gradation modes managed by the gradation mode management unit 321. In the example shown in FIG. 11, the gradation mode management unit 321 of a display 31C manages nine types of the gradation modes. For example, in the display 31C, the Long Linear gradation, the DICOM gradation, and the gamma 2.2 gradation are respectively provided with the gradation mode when an image for single image reading is displayed, the gradation mode (for left-hand neighbor) when images for comparative image reading are displayed on the display 31C and 31L, and the gradation mode (for right-hand neighbor) when images for comparative image reading are displayed on the displays 31C and 31R.

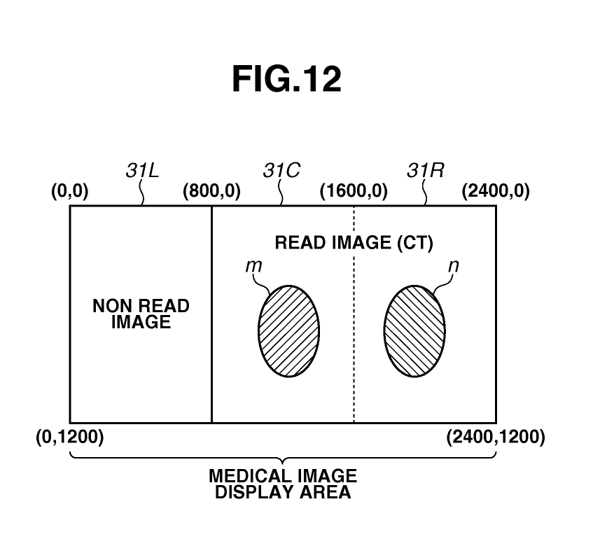

FIG. 12 illustrates an example of a screen configuration in which images for comparative image reading are displayed on the displays 31C and 31R. An area (upper left coordinates, width, and height) in which medical images are displayed by the display application 110 is expressed as ((0, 0), 2400, 1200) in the entire screen. An image reading area for a CT image in a screen of the display application 110 is expressed as ((800, 0), 1600, 1200). Further, an area of the display 31L is expressed as ((0, 0), 800, 1200), an area of the display 31C is expressed as ((800, 0), 800, 1200), and an area of the display 31R is expressed as ((1600, 0), 800, 1200) in the entire screen.

The CT image includes a plurality of read images for comparison (read images m and n). The display 31C displays the read image m, and the display 31R displays the read image n as a comparative image to be a comparison target of the read image. The display 31C displays the read image m based on the gradation characteristic for comparative image reading corresponding to the DICOM gradation mode for the right-hand neighbor. The display 31R displays the read image n based on the gradation characteristic for comparative image reading corresponding to the DICOM gradation mode for the left-hand neighbor. Accordingly, the display gradation characteristic of the display 31C matches with the display gradation characteristic of the display 31R, and thus the display 31C and the display 31R can display the read image m and the read image n under the same conditions.

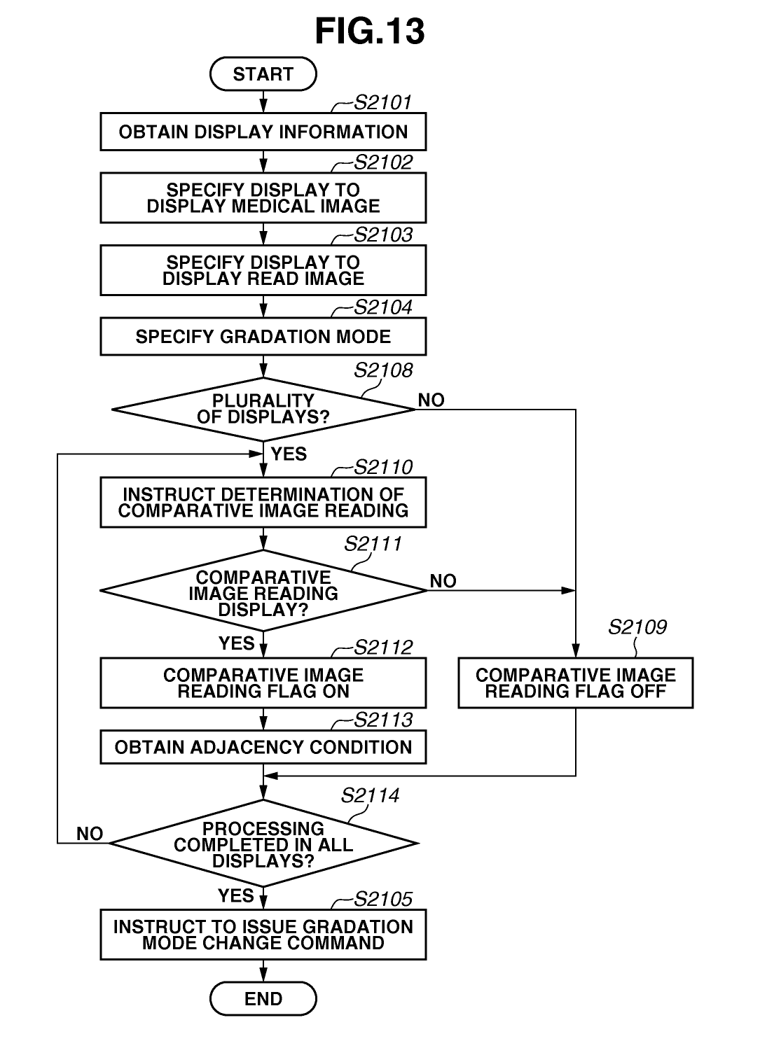

FIG. 13 is a flowchart illustrating operations of the display control apparatus 11 when the read images illustrated in FIG. 12 are displayed on the display 31C and the display 31R. When the image reading screen information is received from the display application 110, the gradation control unit 221 starts processing for controlling the gradation characteristic of the image reading area.

The gradation control unit 221 specifies that the displays 31L, 31C, and 31R display images by the display application 110 by the processing in step S2102 described with reference to FIG. 5. Further, the gradation control unit 221 specifies that the displays 31C and 31R display the CT images by the processing in step S2103 described with reference to FIG. 5. Furthermore, the gradation control unit 221 specifies that the type of the gradation mode of the displays 31C and 31R is the DICOM gradation by the processing in step S2104 described with reference to FIG. 5.

In step S2108, the gradation control unit 221 determines whether there is a plurality of displays 31 displaying the read images. If the gradation control unit 221 determines that there is a display 31 displaying the read image (NO in step S2108), in step S2109, the gradation control unit 221 determines that the read image is not an image for comparative image reading and turns the comparative image reading flag OFF. If the gradation control unit 221 determines that there is a plurality of displays 31 displaying the read image (YES in step S2108), in step S2110, the gradation control unit 221 issues an instruction to determine whether the plurality of displays display images for comparative image reading to the comparative image reading determination unit 240.

In the example illustrated in FIG. 12, the displays 31C and 31R display the read images, so that, in step S2111, the comparative image reading determination unit 240 determines whether the displays 31C and 31R display images for comparative image reading. If the comparative image reading determination unit 240 determines that the displays 31C and 31R display images for comparative image reading (YES in step S2111), in step S2112, the gradation control unit 221 turns the comparative image reading flag ON. A determination method by the comparative image reading determination unit 240 are described in detail below.

Then, in step S2113, the gradation control unit 221 obtains the adjacency condition information. In the example illustrated in FIG. 12, the display 31C displays the image for comparative image reading together with the display 31R, so that the comparative image reading flag of the display 31C is ON, and the adjacency condition thereof is a right-hand neighbor. In addition, the comparative image reading flag of the display 31R is ON, and the adjacency condition thereof is a left-hand neighbor.

Next, in step S2114, the gradation control unit 221 determines whether the comparative image reading determination is completed with respect to all of the displays 31 displaying the read images. If there is a display 31 which is not subjected to the comparative image reading determination (NO in step S2114), in step S2110, the gradation control unit 221 instructs the comparative image reading determination unit 240 to perform the comparative image reading determination. If there is no display 31 which is not subjected to the comparative image reading determination (YES in step S2114), in step S2105, the gradation control unit 221 issues the command issuance instruction to instruct the gradation mode change with respect to the display 31 displaying the read image to the command issuance unit 231.

In the example illustrated in FIG. 12, the command issuance unit 231 transmits to the display 31C the gradation mode change command to change the gradation mode of the display 31C to the DICOM gradation mode in the case of the comparative image reading using the display 31R on the right-hand neighbor. In addition, the command issuance unit 231 transmits to the display 31R the gradation mode change command to change the gradation mode of the display 31R to the DICOM gradation mode in the case of the comparative image reading using the display 31C on the left-hand neighbor.

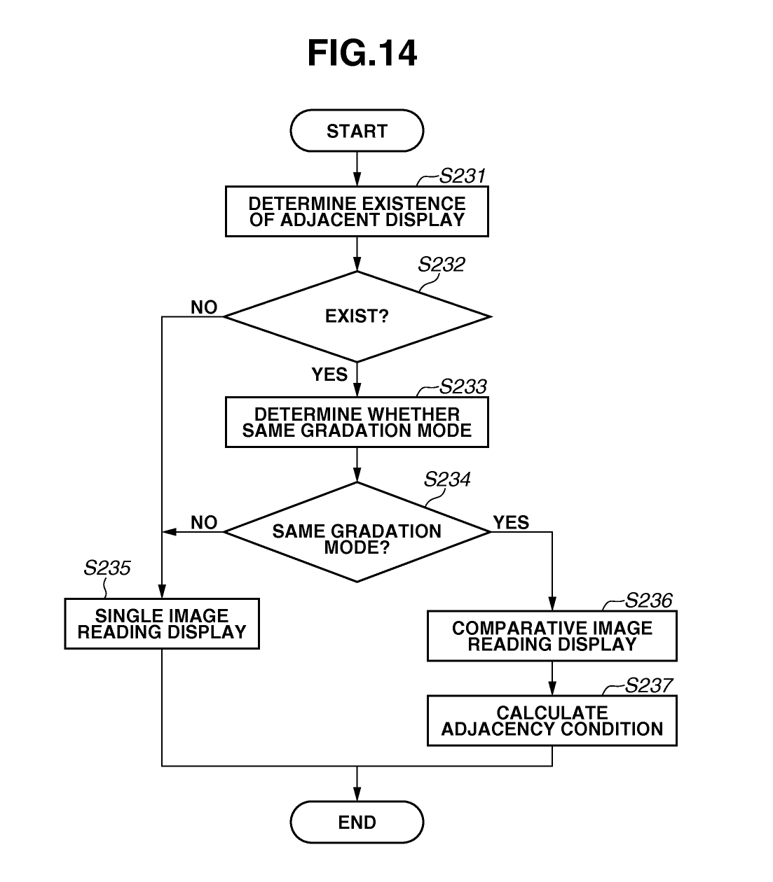

FIG. 14 is a flowchart illustrating operations of the comparative image reading determination unit 240 to determine whether the read image displayed on the display is an image for single image reading or an image for comparative image reading.

In step S231, when the comparative image reading determination instruction is received from the gradation control unit 221, the comparative image reading determination unit 240 determines whether another display 31 exists which is adjacent to one display 31 displaying the read image and displays the read image. In the example illustrated in FIG. 12, the display 31L on the left-hand neighbor of the display 31C does not display the read image, and the display 31R on the right-hand neighbor of the display 31C displays the read image. Therefore, the comparative image reading determination unit 240 determines that the display 31R which is adjacent to the display 31C and displays the read image exists with respect to the display 31C.

If no display 31 exists which is adjacent to a determination target display 31 and displays the read image (NO in step S232), in step S235, the comparative image reading determination unit 240 determines that the determination target display 31 is for the single image reading. If the display 31 exists which is adjacent to the determination target display 31 and displays the read image (YES in step S232), in step S233, the comparative image reading determination unit 240 determines whether the type of the gradation mode when the adjacent display 31 displays the read image matches with the type of the gradation mode when the determination target display 31 displays the read image.

In the example illustrated in FIG. 12, the displays 31C and 31R displays the CT images, so that the comparative image reading determination unit 240 determines that the display 31R on the right-hand neighbor of the display 31C is set to the same DICOM gradation mode as the display 31C. If the type of the gradation mode in the plurality of displays 31 when displaying the read images is the same with each other (YES in step S234), in step S236, the comparative image reading determination unit 240 determines that the displays 31C and 31R are displays displaying images for comparative image reading. In this case, in step S237, the comparative image reading determination unit 240 calculates the adjacency condition. In the example illustrated in FIG. 12, the display 31C is the display displaying the image for comparative image reading together with the display 31R, so that the comparative image reading determination unit 240 calculates the adjacency condition as the right-hand neighbor.

If the type of the gradation mode in the plurality of displays 31 when displaying the read images is not the same with each other (NO in step S234), in step S235, the comparative image reading determination unit 240 determines that the display 31C displays an image for single image reading.

### [Effect According to Third Exemplary Embodiment]

As described above, the display control apparatus 11 according to the third exemplary embodiment determines whether the plurality of displays 31 displaying the read images display images for comparative image reading and, when the plurality of displays 31 display images for comparative image reading, sets the gradation characteristics of the plurality of displays 31 to the gradation characteristic for comparative image reading. In addition, the plurality of displays 31 display the read images based on the gradation characteristic for comparative image reading. Accordingly, when the plurality of displays 31 perform the comparative image reading by displaying images for comparative image reading, a plurality of read images as targets to be compared can be displayed by the same gradation characteristic, and the accuracy of the comparative image reading is improved.

### [Creating Gradation Mode for Comparative Image Reading]

According to the third exemplary embodiment, a correction value corresponding to the gradation characteristic for comparative image reading is prepared in advance, however, a fourth exemplary embodiment is different therefrom at a point that a correction value corresponding to the gradation characteristic for comparative image reading is not prepared in advance.

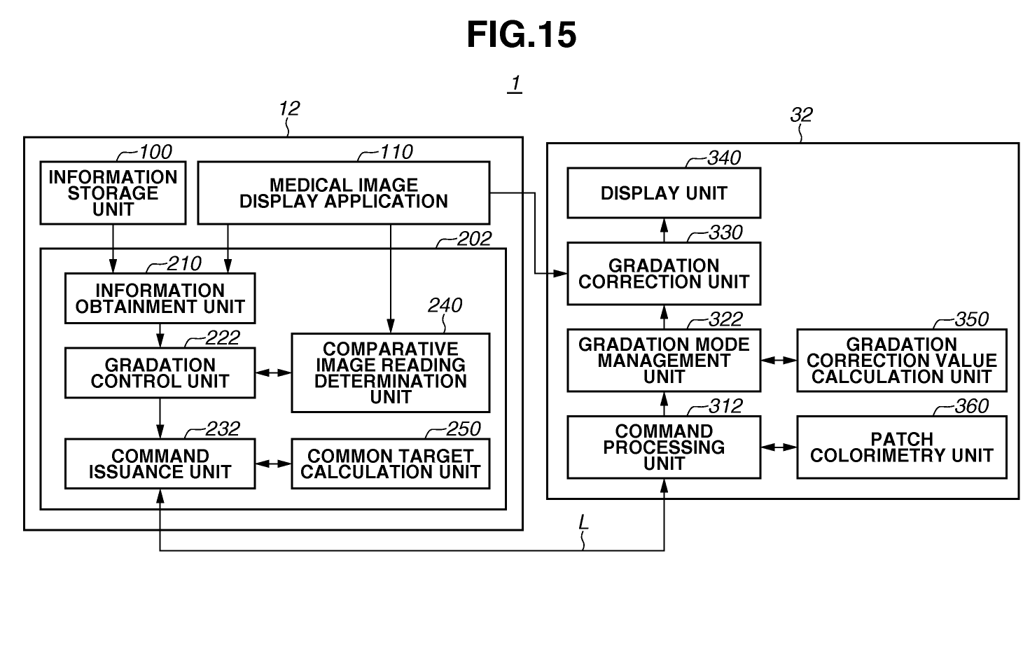

FIG. 15 illustrates a configuration of a display system 1 according to the fourth exemplary embodiment. The display system 1 illustrated in FIG. 15 includes a display control apparatus 12 and a plurality of displays 32 (32L, 32C, and 32R). The display control apparatus 12 is different from the display control apparatus 11 illustrated in FIG. 10 at a point that a control unit 202 corresponding to the control unit 201 in FIG. 10 further includes a common target calculation unit 250. Further, the display control apparatus 12 is different from the display control apparatus 11 at a point that the control unit 202 includes a gradation control unit 222 and a command issuance unit 232 respectively instead of the gradation control unit 221 and the command issuance unit 231.

The display 32 is different from the display 31 illustrated in FIG. 10 at a point that the display 32 further includes a gradation correction value calculation unit 350 and a patch colorimetry unit 360. Further, the display 32 is different from the display 31 at a point that the display 32 includes a command processing unit 312 and a gradation mode management unit 322 respectively instead of the command processing unit 311 and the gradation mode management unit 321.

When the comparative image reading is performed using the plurality of displays 32, the display control apparatus 12 according to the present exemplary embodiment sets the gradation characteristics of the plurality of displays 32 to a common gradation characteristic used by the plurality of displays 32 in common based on a predetermined target gradation characteristic. The plurality of displays 32 create a new gradation mode corresponding to the common gradation characteristic and generate a gradation correction value corresponding to the created gradation mode.

The common gradation characteristic is a gradation characteristic to which the gradation correction value is applied so as to match the gradation characteristics of adjacent two displays 32 with each other. For example, when minimum brightness or maximum brightness are different in the plurality of displays 32, the common gradation characteristic is set based on smaller maximum brightness selected from the maximum brightness values of the respective displays 32 and larger minimum brightness selected from the minimum brightness values of the respective displays 32.

Similar to the third exemplary embodiment, the command issuance unit 232 transmits to the displays 32 the gradation mode change command to set the gradation characteristic for comparative image reading to the display 32 based on the instruction from the gradation control unit 222. According to the present exemplary embodiment, when the display control apparatus 12 receives a notification of a failure in the gradation mode change from the display 32 after the command issuance unit 232 transmits the gradation mode change command, the display control apparatus 12 executes processing for generating a new gradation characteristic for comparative image reading. The display control apparatus 12 receives a notification of a failure in the gradation mode change, for example, when the display does not store a gradation correction value for comparative image reading.

As the processing for generating a new gradation characteristic for comparative image reading, the common target calculation unit 250 first calculates a common target to match the gradation characteristics with each other of the plurality of displays 32 displaying images for comparative image reading. The common target calculation unit 250 receives the maximum brightness and the minimum brightness of respective two displays 32 via the command issuance unit 232 and calculates target maximum brightness and target minimum brightness common to both displays. The maximum brightness and the minimum brightness of the display 32 is brightness measured by, for example, the patch colorimetry unit 360.

The common target calculation unit 250 calculates the smaller one of the maximum brightness values of the two displays 32 as common target maximum brightness. Further, the common target calculation unit 250 calculates the larger one of the minimum brightness values of the two displays 32 as common target minimum brightness. The common target calculation unit 250 supplies the calculated common target maximum brightness and common target minimum brightness to the command issuance unit 232. The command issuance unit 232 transmits the common target maximum brightness and the common target minimum brightness to the display 32.

The gradation correction value calculation unit 350 calculates a gradation correction value corresponding to a new gradation characteristic for comparative image reading based on the common target maximum brightness and the common target minimum brightness transmitted from the command issuance unit 232. Procedures of the gradation correction value calculation unit 350 to calculate the gradation correction value are described in detail below.

The patch colorimetry unit 360 causes the display unit 340 to display a colorimetric patch which is an image used in measurement of brightness of a specified gradation. The colorimetric patch is used to obtain the target maximum brightness and the target minimum brightness necessary for calculating the gradation correction value. Therefore, the colorimetric patch is an image including at least a white patch and a black patch for respectively measuring the maximum brightness and the minimum brightness of the display 32. The patch colorimetry unit 360 obtains a colorimetric value indicating brightness of the colorimetric patch using a colorimeter installed close to a surface of the display unit 340.

### [Gradation Mode Creation Operation]

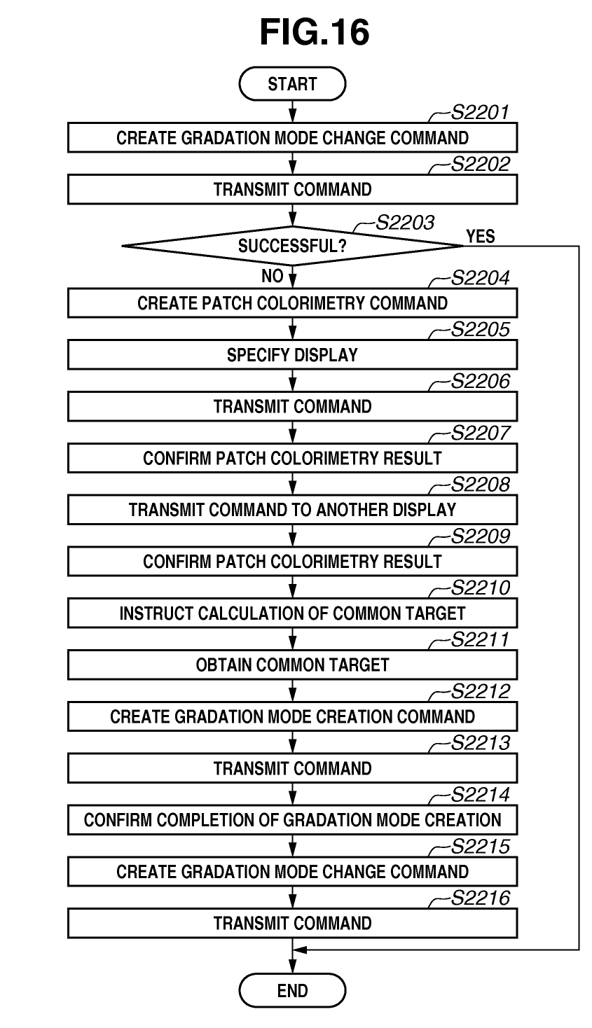

FIG. 16 is a flowchart illustrating operations of the display control apparatus 12 according to the fourth exemplary embodiment to set a new gradation characteristic to the display 32.

When the gradation mode change command issuance instruction is received from the gradation control unit 222, the command issuance unit 232 starts command issuance processing. In step S2201, when the command issuance instruction is received from the gradation control unit 222, the command issuance unit 232 creates a gradation mode change command and, in step S2202, transmits the created command to the display 32. The gradation mode change command created by the command issuance unit 232 includes at least the command identification information, gradation mode information, the comparative image reading flag, and the adjacency condition information.

If a response indicating a success in the gradation mode change is received from the command processing unit 312 (YES in step S2203), the command issuance unit 232 terminates the command issuance processing. If a response indicating a failure in the gradation mode change is received from the command processing unit 312 (NO in step S2203), in step S2204, the command issuance unit 232 creates a patch colorimetry command to execute brightness measurement. The patch colorimetry command created by the command issuance unit 232 includes at least the command identification information and patch display conditions (color, position, size, and the like).

Next, in step S2205, the command issuance unit 232 specifies the plurality of displays 32 which need to match the gradation characteristics thereof with each other based on the adjacency condition information included in the gradation mode change command. In step S2206, the command issuance unit 232 transmits the patch colorimetry command to the command processing unit 312 of the display which has transmitted the response indicating the failure in the gradation mode change among the specified displays 32. Then, in step S2207, the command issuance unit 232 receives a patch colorimetry result from the command processing unit 312. Accordingly, the command issuance unit 232 can obtain the maximum brightness and the minimum brightness of the display 32 which failed the gradation mode change.

In step S2208, the command issuance unit 232 transmits the patch colorimetry command to the command processing unit 312 of another display 32 which needs to match the gradation characteristic. Then, in step S2209, the command issuance unit 232 receives the patch colorimetry result from the command processing unit 312. Accordingly, the gradation mode management unit 322 can obtain the maximum brightness and the minimum brightness of the display 32 which failed the gradation mode change and of the display 32 which needs to match the gradation characteristic with that of the relevant display 32.

In step S2210, the command issuance unit 232 instructs the common target calculation unit 250 to calculate the common target maximum brightness and the common target minimum brightness based on the maximum brightness and the minimum brightness of the respective two displays 32. The instruction includes at least information pieces indicating two maximum brightness values and two minimum brightness values.

In step S2211, the command issuance unit 232 receives the common target maximum brightness and the common target minimum brightness from the common target calculation unit 250. Then, in step S2212, the command issuance unit 232 creates a gradation mode creation command and, in step S2213, transmits the created command to the command processing unit 312 of the display 32. The gradation mode creation command created by the command issuance unit 232 includes at least the command identification information, the gradation mode information, the adjacency condition information, common target information (target maximum brightness and target minimum brightness), colorimetry result information (maximum brightness and minimum brightness). In step S2214, the command issuance unit 232 receives a notification of completion of the gradation mode creation from the command processing unit 312. Then, in step S2215, the command issuance unit 232 creates a gradation mode change command and, in step S2216, transmits the created command to the command processing unit 312 of the display 32.

Operations of the display 32 receiving the gradation mode creation command to create the gradation mode are described below.

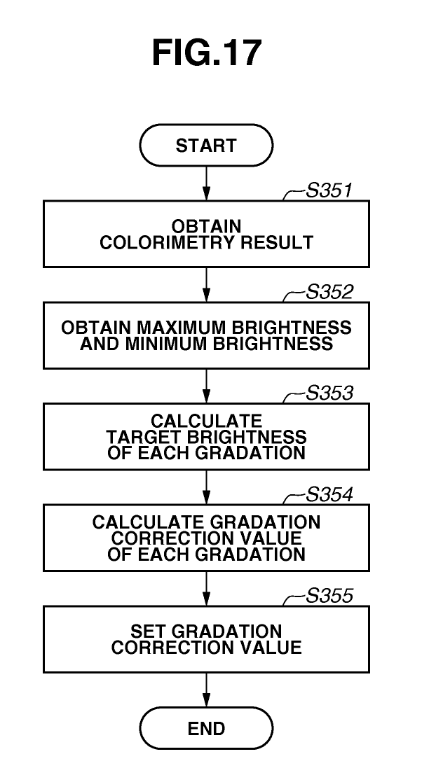

FIG. 17 is a flowchart illustrating operations of the patch colorimetry unit 360 to calculate a gradation correction value to set a gradation characteristic corresponding to a new gradation mode in response to the gradation mode creation command.

When a calculation instruction of the gradation correction value is received from the gradation mode management unit 322 which received the gradation mode creation command via the command processing unit 312, the patch colorimetry unit 360 starts processing for calculating the gradation correction value. In step S351, the patch colorimetry unit 360 obtains maximum brightness Lwt and minimum brightness Lbk from the colorimetry result information included in the calculation instruction received from the gradation mode management unit 322. In step S352, the patch colorimetry unit 360 further obtains target maximum brightness TLwt and target minimum brightness TLbk from the common target information included in the calculation instruction received from the gradation mode management unit 322.

In step S353, the patch colorimetry unit 360 calculates target brightness TLn of each gradation based on the gradation mode type information, the target maximum brightness TLwt, and the target minimum brightness TLbk included in the calculation instruction received from the gradation mode management unit 322. The patch colorimetry unit 360 calculates target brightness of an input gradation in response to the gradation mode. When the type of the gradation mode is the gamma 2.2 gradation, the target brightness of the input gradation INn is expressed as TLn=(INn/INmax)^{2.2}*(TLwt−TLbk)+TLbk.

Next, in step S354, the patch colorimetry unit 360 calculates a gradation correction value OUTn of each gradation based on the maximum brightness Lwt, the minimum brightness Lbk, and the calculated target brightness TLn. When the display characteristic of the display is the gamma 2.2 gradation, the gradation correction value of the target brightness TLn is expressed as OUTn=((TLn−Lbk)/(Lwt−Lbk))^{(1/2.2)}. In step S355, the patch colorimetry unit 360 supplies the calculated gradation correction value OUTn to the gradation mode management unit 322.

The gradation mode management unit 322 stores the gradation correction value supplied from the patch colorimetry unit 360 as the gradation correction value of the new gradation mode. The gradation mode management unit 322 corrects the gradation value of the read image using the gradation correction value supplied from the patch colorimetry unit 360 and thus can display the read image based on the gradation characteristic appropriate for the image for comparative image reading.

### [Effect According to Fourth Exemplary Embodiment]

As described above, when the display 32 does not store a correction value corresponding to the gradation characteristic for comparative image reading, the display system 1 according to the fourth exemplary embodiment calculates a gradation correction value to set a new gradation characteristic to the display 32 based on the maximum brightness and the minimum brightness of each display 32 measured using a colorimetric patch. Accordingly, if the display 32 does not store a correction value corresponding to the gradation characteristic for comparative image reading, images for comparative image reading can be displayed on the plurality of displays 32 using the same gradation characteristic, and the accuracy of the comparative image reading is improved.

In the above descriptions, the patch colorimetry unit 360 measures the maximum brightness and the minimum brightness of the display 32 using the colorimetric patch based on the instruction from the display control apparatus 12, however, the display 32 may obtain the maximum brightness and the minimum brightness using other methods. For example, the display 32 may store the maximum brightness and the minimum brightness measured in a manufacturing process in a nonvolatile memory.

While aspects of the present invention have been described with reference to exemplary embodiments, it is to be understood that these disclosed exemplary embodiments are not seen to be limiting. The scope of the following claims is to be accorded the broadest interpretation so as to encompass all such modifications and equivalent structures and functions.

For example, according to the above exemplary embodiments, it is described that the displays 30, 31, and 32 include 800*1200 pixels, however, the number of pixels of the displays 30, 31, and 32 can be changed according to a setting value of screen resolution. In this case, the display control apparatuses 10, 11, and 12 may specify the displays 30, 31, and 32 displaying read images and areas in which the read image are displayed again at a timing switching the screen resolution.

### Other Embodiments

Additional embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

This application claims the benefit of Japanese Patent Application No. 2014-168355, filed Aug. 21, 2014, which is hereby incorporated by reference herein in its entirety.

What is claimed is:

1. A display control apparatus controlling gradation characteristics of a plurality of display apparatuses displaying read images, the display control apparatus comprising:
an obtaining unit configured to obtain image reading area information indicating a display area of the read image and image type information indicating a type of the read image;
a specifying unit configured to specify, based on the image reading area, one or more display apparatuses displaying the read images from among the plurality of display apparatuses; and
a setting unit configured to set gradation characteristics of the one or more display apparatuses specified by the specifying unit to gradation characteristics corresponding to the image type information.

2. The display control apparatus according to claim 1, wherein the obtaining unit further obtains size information indicating screen sizes of the plurality of display apparatuses and arrangement information indicating arrangement of the plurality of display apparatuses, and
wherein the specifying unit generates coordinate information of a display screen comprising the plurality of display apparatuses based on the size information and the arrangement information and specifies the one or more display apparatuses based on the generated coordinate information and the image reading area information.

3. The display control apparatus according to claim 1, wherein the specifying unit specifies an area in which the read image is displayed in the one or more display apparatuses displaying the read images, and
wherein the setting unit sets a gradation characteristic of an area specified by the specifying unit to a gradation characteristic corresponding to a type of the read image.

4. The display control apparatus according to claim 3, wherein, in a case where the specifying unit specifies that a first display apparatus displays the read image and a second display apparatus other than the first display apparatus displays a comparison image as a target compared with the read image from among the plurality of display apparatuses, the setting unit sets a gradation characteristic of the first display apparatus to a gradation characteristic for comparative image reading that is preliminarily determined in association with the second display apparatus.

5. The display control apparatus according to claim 3, wherein, in a case where the specifying unit specifies that a first display apparatus displays the read image and a second display apparatus other than the first display apparatus displays a comparison image as a target compared with the read image among the plurality of display apparatuses, the setting unit sets a gradation characteristic of the first display apparatus and a gradation characteristic of the second display apparatus to a common gradation characteristic that the first display apparatus and the second display apparatus use in common based on a predetermined target gradation characteristic.

6. The display control apparatus according to claim 5, wherein the setting unit sets the common gradation characteristic based on smaller maximum brightness selected from maximum brightness of the first display apparatus and maximum brightness of the second display apparatus and larger minimum brightness selected from minimum brightness of the first display apparatus and minimum brightness of the second display apparatus.

7. The display control apparatus according to claim 6, wherein the setting unit sets the common gradation characteristic based on the maximum brightness and the minimum brightness of the first display apparatus measured using a colorimetric image displayed by the first display apparatus and the maximum brightness and the minimum brightness of the second display apparatus measured using a colorimetric image displayed by the second display apparatus.

8. The display control apparatus according to claim 1, wherein, in a case where a display area of the read image is changed, the specifying unit specifies one or more display apparatuses displaying the read images.

9. A display apparatus comprising a display unit configured to display a read image based on a gradation characteristic set by a display control apparatus according to claim 1.

10. A display system comprising:
a plurality of display apparatuses configured to display read images; and
a display control apparatus configured to control gradation characteristics of the plurality of display apparatuses, the display control apparatus comprising:
an obtaining unit configured to obtain image reading area information indicating a display area of the read image and image type information indicating a type of the read image;
a specifying unit configured to specify, based on the image reading area information, one or more display apparatuses displaying the read images among the plurality of display apparatuses; and
a setting unit configured to set gradation characteristics of the one or more display apparatuses specified by the specifying unit to gradation characteristics corresponding to the image type information,
wherein the one or more display apparatuses specified by the specifying unit display the read images based on the gradation characteristics set by the setting unit.

11. The display system according to claim 10,
wherein the one or more display apparatuses specified by the specifying unit display the read images by correcting a predetermined gradation characteristic based on a correction value corresponding to the gradation characteristics set by the setting unit.

12. A method of display control for controlling gradation characteristics of a plurality of display apparatuses displaying read images, the method comprising:
obtaining image reading area information indicating a display area of the read image and image type information indicating a type of the read image;
specifying, based on the image reading area information, one or more display apparatuses displaying the read images from among the plurality of display apparatuses; and
setting gradation characteristics of the one or more display apparatuses specified by the specifying procedure to gradation characteristics corresponding to the image type information.

13. The method according to claim 12, further comprising
obtaining size information indicating screen sizes of the plurality of display apparatuses and arrangement information indicating arrangement of the plurality of display apparatuses, wherein, coordinate information of a display screen comprising the plurality of display apparatuses is generated based on the size information and the arrangement information and the one or more display apparatuses is specified based on the generated coordinate information and the image reading area information.

14. The method according to claim 12,
wherein an area in which the read image is displayed is specified in the one or more display apparatuses displaying the read images, and wherein a gradation characteristic of a specified area is set to a gradation characteristic corresponding to a type of the read image.

15. The method according to claim 14,
wherein, in a case where it is specified that a first display apparatus displays the read image and a second display apparatus other than the first display apparatus displays a comparison image as a target compared with the read image from among the plurality of display apparatuses, a gradation characteristic of the first display apparatus is set to a gradation characteristic for comparative image reading which is preliminarily determined in association with the second display apparatus.

16. The method according to claim 14,
wherein, in a case where it is specified that a first display apparatus displays the read image and a second display apparatus other than the first display apparatus displays a comparison image as a target compared with the read image from among the plurality of display apparatuses, a gradation characteristic of the first display apparatus and a gradation characteristic of the second display apparatus are set to a common gradation characteristic that the first display apparatus and the second display apparatus use in common based on a predetermined target gradation characteristic.

17. The method according to claim 16,
wherein the common gradation characteristic is set based on smaller maximum brightness selected from maximum brightness of the first display apparatus and maximum brightness of the second display apparatus and larger minimum brightness selected from minimum brightness of the first display apparatus and minimum brightness of the second display apparatus.

18. The method according to claim 17, further comprising:
measuring the maximum brightness and the minimum brightness of the first display apparatus using a colorimetric image displayed by the first display apparatus; and
measuring the maximum brightness and the minimum brightness of the second display apparatus using a colorimetric image displayed by the second display apparatus,
wherein the common gradation characteristic is set based on the maximum brightness and the minimum brightness of the first display apparatus and the maximum brightness and the minimum brightness of the second display apparatus.

19. The method according to claim 12, further comprising:
detecting that a display area of the read image is changed,
wherein, in a case where it is detected that a display area of the read image is changed, one or more display apparatuses displaying the read images are specified.

20. A computer-readable storage medium storing computer executable instructions for causing a computer to execute a method of display control for controlling gradation characteristics of a plurality of display apparatuses displaying read images, the method comprising:
obtaining image reading area information indicating a display area of the read image and image type information indicating a type of the read image;
specifying, based on the image reading area information, one or more display apparatuses displaying the read images from among the plurality of display apparatuses; and
setting gradation characteristics of the one or more display apparatuses specified by the specifying procedure to gradation characteristics corresponding to the image type information.
